(19) United States
(12) Patent Application Publication
(10) Pub. No.: US 2016/0210823 A1
(43) Pub. Date: Jul. 21, 2016

(54) Chinese video poker

(71) Applicant: Brian Haveson, Boothwyn, PA (US)

(72) Inventor: Brian Haveson, Boothwyn, PA (US)

(21) Appl. No.: 14/544,560

(22) Filed: Jan. 21, 2015

(51) Int. Cl. G07F 17/32

(52) U.S. Cl. CPC G07F 17/3293; G07F 17/3244

(57) ABSTRACT

A gaming system having a thirteen-card poker game is provided. The gaming system causes an initial five cards to be dealt to the player from a standard 52-card poker deck. The player is required to place each of those cards in one of thirteen positions on the screen. The player places those cards in such a way as to maximize expected return. The positions consist of a three-card position on top, a five-card position in the middle and a five-card position on the bottom. The player places those cards in such a way as to maximize his return based on a pre-defined pay-table that pays for poker hands in the top, middle, and bottom positions. Each poker hand that is created must beat or tie the hand above it or the hand is considered fouled and the player wins nothing regardless of the pay-table. After the player has decided which positions to fill in with his initial five cards, he hits a draw button. The gaming system randomly draws eight additional cards from the remaining forty-seven cards in the deck. The gaming system then automatically uses an algorithm to determine the best placement of those eight additional cards based on a pre-defined pay-table and then automatically fills in the remaining cards. The algorithm will also avoid a foul situation if possible. The win, if any is then calculated. Alternative form of the game is all thirteen cards are dealt at once and the computer or the player sets the cards all at one time. Alternative form of the game is first five cards are dealt and placed by player. The player is then dealt one card at a time and places them one at a time until all thirteen cards are placed. Once a card is placed it cannot be moved after the next card is dealt. Alternative form of the game is first 5 cards are dealt and placed by player. The player is then dealt three cards at a time and places two cards at a time until all thirteen cards are placed. The card that is not placed is discarded. Once the two cards are placed, they cannot be moved after the next three cards are dealt.

The present invention relates to the general field of video poker games and more specifically to gaming system, gaming device and method for providing an enhanced Chinese Video Poker or thirteen-card video poker game for real live gambling, internet gambling and social gaming.

The aim of the traditional Chinese poker game is to arrange thirteen cards into three poker hands—two of five cards and one of three cards—which will beat the corresponding poker hands made by the other players. In the traditional game, there are two to four players, each playing against one another, using a standard 52-card deck. The players typically agree on stakes in terms of units before playing, e.g., $1, $10, $100 per unit. There are three popular forms of Chinese Poker being played in Casinos and over the internet. They are traditional Chinese Poker, Openface Chinese poker and Pineapple OpenFace Chinese Poker. In traditional Chinese Poker, the cards are shuffled, cut and dealt out one at a time until each player has thirteen cards. The player then places all 13 cards facedown in the 13 available positions. In Openface Chinese Poker, each player is dealt 5 cards facedown and must place them in any of 13 positions available face up. The player to the left of the dealer acts first. After all players have placed the five cards, the players are dealt one card each facedown to be placed faceup until all 13 positions are filled. The player to the left of the dealer always acts first. In Pineapple Chinese Poker, each player is dealt 5 cards facedown and must place them in any of 13 positions available face up. The player to the left of the dealer acts first. After all players have placed the five cards, the players are dealt 3 cards each facedown and must place 2 of 3 cards face up and discard the remaining card. Play continues until all 13 positions have been filled. Each player must divide their thirteen cards into a “bottom” hand of five cards, a “middle” hand of five cards and a “top” hand of three cards. Considered as poker hands, the “bottom” hand must be better than the “middle” hand, and the “middle” hand must be better than the “top” hand. If a player sets a handed that does not comply with this criteria, his hand is considered fouled and he will lose to all other players. The standard poker ranking is used, so the hand types from high to low are: royal flush, straight flush, four of a kind, full house, flush, straight, three of a kind, two pairs, one pair, high card. There are no wild cards.

Since the “top” hand has only three cards, only three hand types are possible: three of a kind; one pair; high card. There is no value in having a front hand with three consecutive cards or three cards of the same suit: “straights” or “flushes” in the front hand do not count.

The rankings of the three cards, from highest to lowest poker hand, is as follows:

(1) three aces A-A-A;

(2) a royal flush formed by A-K-Q of the same suit;

(3) a straight flush formed by three cards in consecutive rank of the same suit, wherein the highest ranking straight flush is A-K-Q of the same suit and the second highest is K, Q, J of the same suit;

(4) a flush formed by three cards of the same suit, regardless of rank, wherein the highest ranking card determines the highest flush;

(5) a straight formed by three cards consecutive in rank, regardless of suit, wherein the highest ranking card will determine the highest straight, wherein A-K-Q is the highest ranking straight, K-Q-J is the second highest straight and 4-3-2 is the lowest straight;

(6) three of a kind formed by three cards of the same rank regardless of suit wherein three aces is the highest ranking three of a kind and three twos is the lowest ranking three of a kind;

(7) two pair hand;

(8) one pair wherein two aces is the highest ranking pair and two twos is the lowest ranking pair; and

(9) no pair, which occurs when none of the poker hands set forth above are formed and wherein the highest ranking single card will determine the winner wherein, and in comparing hands of a player of the of that dealer, the highest ranking card is identical, the next highest ranking card will determine the winner.

After all hands are set, the player's hands are evaluated to determine the winners. Each players hand in each position is compared with the others players hands in each position to determine a winner. There are many different scoring systems and bonuses for certain difficult to achieve hands. Each player then pays each other accordingly.

### SUMMARY

The subject invention comprises a gaming system having a thirteen-card poker game is provided. The gaming system causes an initial five cards to be dealt to the player from a standard 52-card poker deck. The player is required to place each of those cards in one of thirteen positions on the screen. The player places those cards in such a way as to maximize expected return. The positions consist of a three-card position on top, a five-card position in the middle and a five-card position on the bottom. The player places those cards in such a way as to maximize his return based on a pre-defined pay-table that pays for poker hands in the top, middle, and bottom positions. Each poker hand that is created must beat or tie the hand above it or the hand is considered fouled and the player wins nothing regardless of the pay-table. After the player has decided which positions to fill in with his initial five cards, he hits a draw button. The gaming system randomly draws eight additional cards from the remaining forty-seven cards in the deck. The gaming system then automatically uses an algorithm to determine the best placement of those eight additional cards based on a pre-defined pay-table and then automatically fills in the remaining cards. The algorithm will also avoid a foul situation if possible. The win, if any is then calculated based on the paytable.

Alternative form of the game is all thirteen cards are dealt at once and the computer or the player sets the cards all at one time.

Another alternative form of the game is first five cards are dealt and placed by player. Once the five cards are placed, they can not be moved. The player is then dealt one card at a time and places them one at a time until all thirteen cards are placed. Once a card is placed it cannot be moved after the next card is dealt.

In yet another alternative form of the game is first five cards are dealt and placed by player. Once the five cards are placed, they can not be moved. The player is then dealt three cards at a time and places two cards at a time until all thirteen cards are placed. The card that is not placed is discarded. Once the two cards are placed, they cannot be moved after the next three cards are dealt.

### BRIEF DESCRIPTION OF THE FIGURES

FIG. 1 comprises a flowchart illustrating a method of operating an example embodiment of the gaming system of the present disclosure configured to operate a single player card game.

FIGS. 2A, 2B, 2C, and 2D, illustrate screen shots of the gaming system of the present disclosure operating an example single player card game of the present disclosure.

FIG. 3 illustrates an example of a pay-table, comprising a payout schema for each poker hand in the top row, the middle row and bottom row.

FIG. 4 is a schematic block diagram of one embodiment of a network configuration of the gaming system of the present disclosure.

FIG. 5 is a schematic block diagram of an example electronic configuration of the gaming system of the present disclosure.

FIG. 6 is a perspective view of example alternative embodiments of the gaming system of the present disclosure.

### DESCRIPTION OF THE PREFERRED EMBODIMENTS

Various embodiments of the present disclosure are directed to a gaming system and method providing a Chinese video poker game.

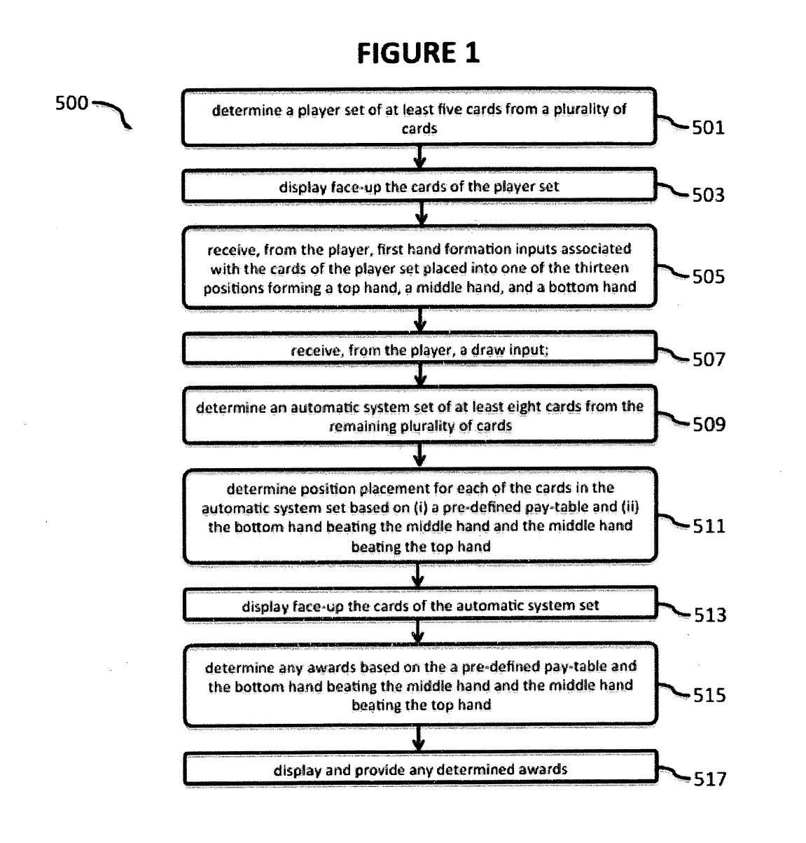

FIG. 1 illustrates a flowchart of an example process or method 500 of operating the gaming system of the present disclosure. In various embodiments, process 500 is represented by a set of instructions stored in one or more memories and executed by one or more processors. Although process 500 is described with reference to the flowchart shown in FIG. 1, it should be appreciated that many other processes of performing the acts associated with this illustrated process may be employed. For example, the order of certain of the illustrated blocks may be changed, certain of the illustrated blocks may be optional, and/or certain of the illustrated blocks may not be employed.

In this example, the gaming system is configured to operate a card game associated with a plurality of cards. In a preferred embodiment, the plurality comprises a standard deck of fifty-two cards, without a wild card or Joker. For a play of the card game for a player, the gaming system determines a player set of at least five cards from the plurality of cards, as indicated by block 501. The gaming system displays face-up the cards of the player set, as indicated by block 503. The gaming system receives, from the player, first hand formation inputs associated with the cards of the player set placed into one of the thirteen positions forming a top hand, a middle hand, and a bottom hand, as indicated by block 505. In other words, the player places those cards in such a way as to maximize his return based on a pre-defined pay-table that pays for poker hands in the top, the middle, and the bottom positions. Each poker hand that is created must beat or tie the hand above it or the hand is considered fouled and the player wins nothing regardless of the pay-table. The gaming system receives, from the player, a draw input, as indicated by block 507. In one embodiment, after the player has decided which positions to fill in with his initial 5 cards, the player hits a draw button.

The gaming system determines an automatic system set of at least eight cards from the remaining plurality of cards, as indicated by block 509. In one embodiment, the gaming system randomly draws 8 additional cards from the remaining 47 cards in the deck as part of block 509. The gaming system determines position placement for each of the cards in the automatic system set based on (i) a pre-defined pay-table and (ii) the bottom hand beating the middle hand and the middle hand beating the top hand, as indicated by block 511. In another embodiment, the gaming system automatically uses an algorithm to determine the best placement of those 8 additional cards based on a pre-defined pay-table, and then automatically fills in the remaining cards. The gaming system display face-up the cards of the automatic system set, as indicated by block 513. The gaming system determines any awards based on the a pre-defined pay-table and the bottom hand beating the middle hand and the middle hand beating the top hand, as indicated by block 515. The gaming system algorithm also avoids a foul situation if possible. The gaming system calculates an award, if any. The gaming system displays and provides any determined awards, as indicated by block 517.

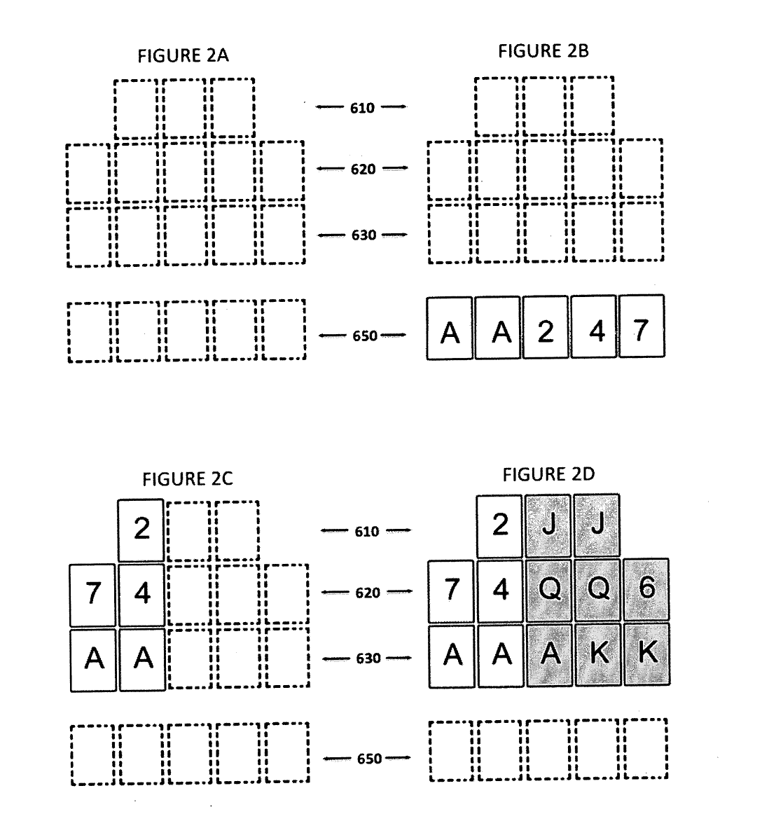

FIGS. 2A, 2B, 2C, and 2D illustrate screen shots of the gaming system of the present disclosure operating one example of the Chinese Video Poker card game. In this example, the enhanced Chinese Video Poker game is associated with a plurality of cards including a standard fifty-two (52) card deck of playing cards, without a wild card or Joker. It should be appreciated, however, that the plurality of cards may include any suitable cards, such as multiple decks of cards or standard decks of cards including Jokers. The gaming system displays comprise four rows. A top row 610 can hold three cards. Immediately below top row 610 is a middle row 620, which can hold five cards. Immediately below middle row 620 is a bottom row 630, which can also hold five cards. Immediately below bottom row 630 is a gaming system display area 650, which comprises a five-card hand display.

FIG. 2B shows the screen shot once the gaming system has determined and has displayed in the gaming system display area 650 five cards A, A, 2, 4, and 7 comprising the player set.

FIG. 2C shows the screen shot once the player has determined the positions to place each of the cards from the gaming system display area 650, selecting the one 2-card in the top row 610, the two 7-4 cards in the middle row 620 and the two A-A cards in the bottom row 630.

FIG. 2D shows the screen shot after the player hits a draw button and once the gaming system has selected the additional eight cards J, J, Q, Q, 6, A, K, K from the remaining forty-seven card deck. The gaming system automatically uses an algorithm to determine the best placement of those eight additional cards based on a pre-defined pay-table, and then automatically fills in the remaining cards, placing cards J-J in the top row 610, cards Q-Q-6 in the middle row 620 and cards A-K-K in the bottom row 630. The gaming system will also avoid a foul situation, if possible.

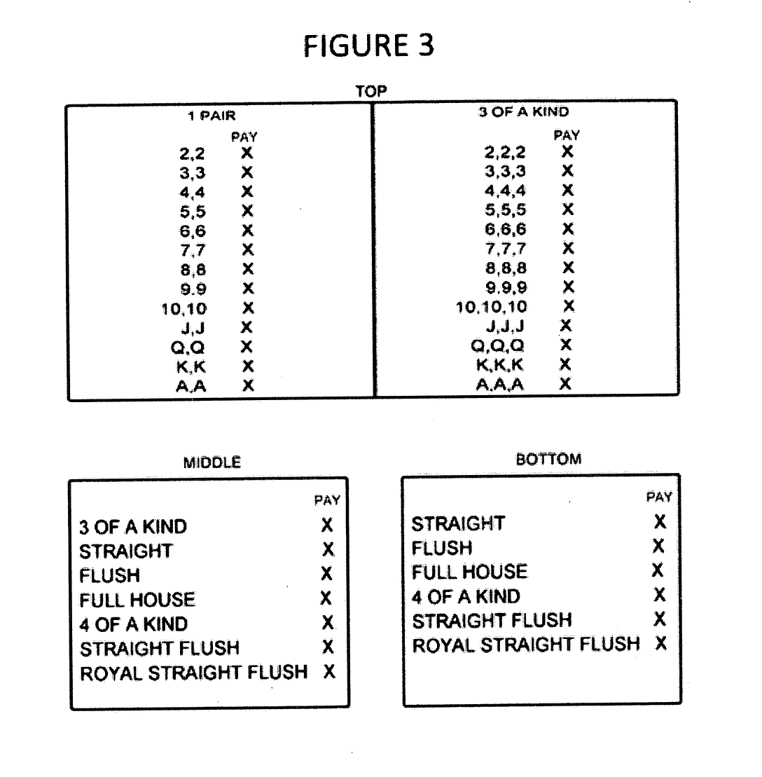

FIG. 3 comprises one embodiment of a pay-table, illustrating a payout schema for each of the top row 610, the middle row 620 and bottom row 630.

While the card game of the present disclosure is a primary game in the embodiments described below, it should be appreciated that the card game may additionally or alternatively be employed as or in association with a secondary game or a bonus game. Moreover, while the credit balances, the wagers, and the awards are each displayed as an amount of monetary credits or currency in the embodiments described below, one or more of such credit balances, such wagers, and such awards may be for non-monetary credits, promotional credits, and/or player tracking points or credits.

While the embodiments of the card game described herein are described as being operated on a gaming system, such as an electronic video poker device, it should be appreciated that the card game of the present disclosure may be provided at a physical card table. In certain such embodiments, the physical card table includes an embedded processor and electronic display. In some variations, each player has an individual display to support functions such as banking, wagering, and viewing of status. In other such embodiments, the card game is provided at a “smart table” that employs a display device (such as a display device including a touch screen, as further described below) for each player that is configured to display electronic playing cards.

It should be appreciated that the above-described embodiments of the present disclosure may be implemented in accordance with or in conjunction with one or more of a variety of different types of gaming systems.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more electronic video poker devices; and/or (c) one or more personal gaming devices, such as desktop computers, laptop computers, tablet computers or computing devices, personal digital assistants (PDAs), mobile telephones such as smart phones (e.g., using Apple iOS, Google Android, and Windows Mobile operating systems), and other mobile computing devices.

Thus, in various embodiments, the gaming system of the present disclosure includes: (a) one or more electronic video poker devices in combination with one or more central servers, central controllers, or remote hosts; (b) one or more personal gaming devices in combination with one or more central servers, central controllers, or remote hosts; (c) one or more personal gaming devices in combination with one or more electronic video poker devices; (d) one or more personal gaming devices, one or more electronic video poker devices, and one or more central servers, central controllers, or remote hosts in combination with one another; (e) a single electronic video poker device; (f) a plurality of electronic video poker devices in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity, each electronic video poker device and each personal gaming device of the present disclosure is collectively referred to herein as an “electronic video poker device.” Additionally, for brevity and clarity, unless specifically stated otherwise, “electronic video poker device” as used herein represents one electronic video poker device or a plurality of electronic video poker devices, and “central server, central controller, or remote host” as used herein represents one central server, central controller, or remote host or a plurality of central servers, central controllers, or remote hosts.

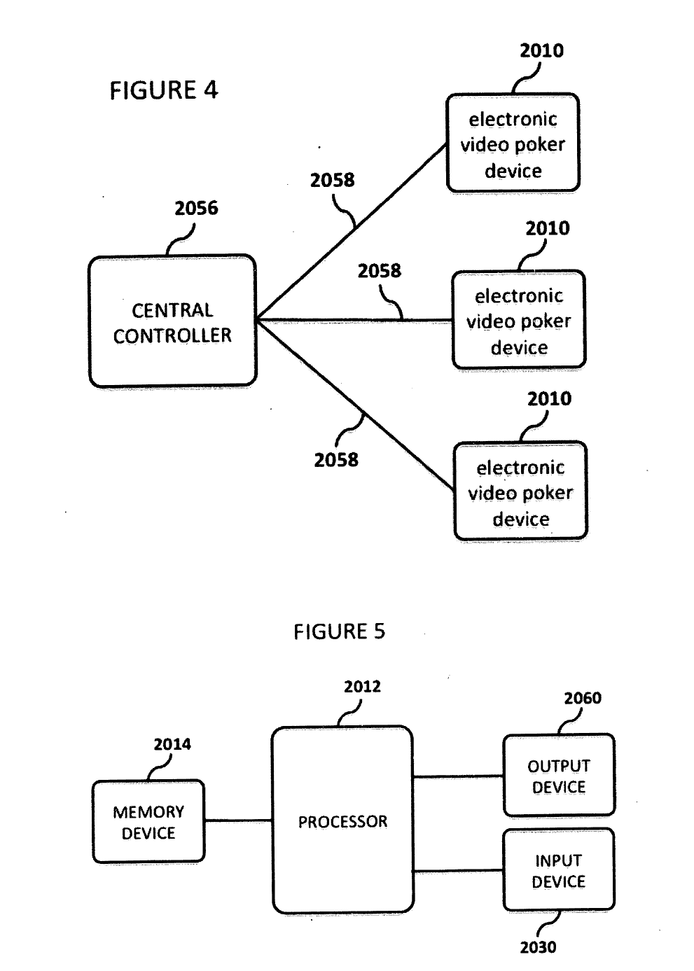

As noted above, in various embodiments, the gaming system includes an electronic video poker device in combination with a central server, central controller, or remote host. In such embodiments, the electronic video poker device is configured to communicate with the central server, central controller, or remote host through a data network or remote communication link. In certain such embodiments, the electronic video poker device is configured to communicate with another electronic video poker device through the same data network or remote communication link or through a different data network or remote communication link. For example, the gaming system illustrated in FIG. 4 includes a plurality of electronic video poker devices 2010 that are each configured to communicate with a central server, central controller, or remote host 2056 through a data network 2058.

In certain embodiments in which the gaming system includes an electronic video poker device in combination with a central server, central controller, or remote host, the central server, central controller, or remote host is any suitable computing device (such as a server) that includes at least one processor and at least one memory device or storage device. As further described below, the electronic video poker device includes at least one electronic video poker device processor configured to transmit and receive data or signals representing events, messages, commands, or any other suitable information between the electronic video poker device and the central server, central controller, or remote host. The at least one processor of that electronic video poker device is configured to execute the events, messages, or commands represented by such data or signals in conjunction with the operation of the electronic video poker device. Moreover, the at least one processor of the central server, central controller, or remote host is configured to transmit and receive data or signals representing events, messages, commands, or any other suitable information between the central server, central controller, or remote host and the electronic video poker device. The at least one processor of the central server, central controller, or remote host is configured to execute the events, messages, or commands represented by such data or signals in conjunction with the operation of the central server, central controller, or remote host. It should be appreciated that one, more, or each of the functions of the central server, central controller, or remote host may be performed by the at least one processor of the electronic video poker device. It should be further appreciated that one, more, or each of the functions of the at least one processor of the electronic video poker device may be performed by the at least one processor of the central server, central controller, or remote host.

In certain such embodiments, computerized instructions for controlling any games (such as any primary or base games and/or any secondary or bonus games) displayed by the electronic video poker device are executed by the central server, central controller, or remote host. In such “thin client” embodiments, the central server, central controller, or remote host remotely controls any games (or other suitable interfaces) displayed by the electronic video poker device, and the electronic video poker device is utilized to display such games (or suitable interfaces) and to receive one or more inputs or commands. In other such embodiments, computerized instructions for controlling any games displayed by the electronic video poker device are communicated from the central server, central controller, or remote host to the electronic video poker device and are stored in at least one memory device of the electronic video poker device. In such “thick client” embodiments, the at least one processor of the electronic video poker device executes the computerized instructions to control any games (or other suitable interfaces) displayed by the electronic video poker device.

In various embodiments in which the gaming system includes a plurality of electronic video poker devices, one or more of the electronic video poker devices are thin client electronic video poker devices and one or more of the electronic video poker devices are thick client electronic video poker devices. In other embodiments in which the gaming system includes one or more electronic video poker devices, certain functions of one or more of the electronic video poker devices are implemented in a thin client environment, and certain other functions of one or more of the electronic video poker devices are implemented in a thick client environment. In one such embodiment in which the gaming system includes an electronic video poker device and a central server, central controller, or remote host, computerized instructions for controlling any primary or base games displayed by the electronic video poker device are communicated from the central server, central controller, or remote host to the electronic video poker device in a thick client configuration, and computerized instructions for controlling any secondary or bonus games or other functions displayed by the electronic video poker device are executed by the central server, central controller, or remote host in a thin client configuration.

In certain embodiments in which the gaming system includes: (a) an electronic video poker device configured to communicate with a central server, central controller, or remote host through a data network; and/or (b) a plurality of electronic video poker devices configured to communicate with one another through a data network, the data network is a local area network (LAN) in which the electronic video poker devices are located substantially proximate to one another and/or the central server, central controller, or remote host. In one example, the electronic video poker devices and the central server, central controller, or remote host, are located in a gaming establishment or a portion of a gaming establishment.

In other embodiments in which the gaming system includes: (a) an electronic video poker device configured to communicate with a central server, central controller, or remote host through a data network; and/or (b) a plurality of electronic video poker devices configured to communicate with one another through a data network, the data network is a wide area network (WAN) in which one or more of the electronic video poker devices are not necessarily located substantially proximate to another one of the electronic video poker devices and/or the central server, central controller, or remote host. For example, one or more of the electronic video poker devices are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the electronic video poker devices are located. In certain embodiments in which the data network is a WAN, the gaming system includes a central server, central controller, or remote host and an electronic video poker device each located in a different gaming establishment in a same geographic area, such as a same city or a same state. It should be appreciated that gaming systems in which the data network is a WAN are substantially identical to gaming systems in which the data network is a LAN, though the quantity of electronic video poker devices in such gaming systems may vary relative to one another.

In further embodiments in which the gaming system includes: (a) an electronic video poker device configured to communicate with a central server, central controller, or remote host through a data network; and/or (b) a plurality of electronic video poker devices configured to communicate with one another through a data network, the data network is an internet or an intranet. In certain such embodiments, an Internet browser of the electronic video poker device is usable to access an interne game page from any location where an interne connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the electronic video poker device, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the interne browser of the electronic video poker device.

It should be appreciated that the central server, central controller, or remote host and the electronic video poker device are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet or MIFI network), or any other suitable medium. It should be appreciated that the expansion in the quantity of computing devices and the quantity and speed of Internet connections in recent years increases opportunities for players to use a variety of electronic video poker devices to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

FIG. 5 depicts an embodiment comprising an electronic video poker device includes at least one processor 2012 configured to operate with at least one memory device 2014, at least one input device 2030, and at least one output device 2060. The at least one processor 2012 may be any suitable processing device or set of processing devices, such as a microprocessor, a microcontroller-based platform, a suitable integrated circuit, or one or more application-specific integrated circuits.

As generally noted above, the at least one processor of the electronic video poker device is configured to communicate with, configured to access, and configured to exchange signals with at least one memory device 2014 or data storage device. In various embodiments, the at least one memory device 2014 of the electronic video poker device includes random access memory (RAM), which can include non-volatile RAM, magnetic RAM, ferroelectric RAM, and other forms as commonly understood in the gaming industry. In other embodiments, the at least one memory device includes read only memory (ROM). In certain embodiments, the at least one memory device 2014 of the electronic video poker device includes flash memory and/or EEPROM. It should be appreciated that any other suitable magnetic, optical, and/or semiconductor memory may operate in conjunction with the electronic video poker device disclosed herein. In certain embodiments, the at least one processor 2012 of the electronic video poker device and the at least one memory device 2014 of the electronic video poker device both reside within a cabinet of the electronic video poker device. In other embodiments, at least one of the at least one processor of the electronic video poker device and the at least one memory device of the electronic video poker device reside outside the cabinet of the electronic video poker device.

In certain embodiments, as generally described above, the at least one memory device of the electronic video poker device stores program code and instructions executable by the at least one processor of the electronic video poker device to control the electronic video poker device. The at least one memory device of the electronic video poker device also stores other operating data, such as image data, event data, input data, random number generators (RNGs) or pseudo-RNGs, pay-table data or information, and/or applicable game rules that relate to the play of one or more games on the electronic video poker device (such as primary or base games and/or secondary or bonus games as described below). In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a player uses such a removable memory device in an electronic video poker device to implement at least part of the present disclosure. In other embodiments, part or all of the program code and/or the operating data is downloaded to the at least one memory device of the electronic video poker device through any suitable data network described above (such as an internet or intranet).

In various embodiments, the electronic video poker device includes one or more input devices 2030. The input devices may include any suitable device that enables an input signal to be produced and received by the at least one processor of the electronic video poker device. The example electronic video poker device illustrated in FIG. 5 includes at least one input device 1030. One input device of the electronic video poker device is a payment device configured to communicate with the at least one processor of the electronic video poker device to fund the electronic video poker device. In certain embodiments, the payment device includes one or more of: (a) a bill acceptor into which paper money is inserted to fund the electronic video poker device; (b) a ticket acceptor into which a ticket or a voucher is inserted to fund the electronic video poker device; (c) a coin slot into which coins or tokens are inserted to fund the electronic video poker device; (d) a reader or a validator for credit cards, debit cards, or credit slips into which a credit card, debit card, or credit slip is inserted to fund the electronic video poker device; (e) a player identification card reader into which a player identification card is inserted to fund the electronic video poker device; or (f) any suitable combination thereof. FIG. 9 illustrates example electronic video poker devices.

In one embodiment, the electronic video poker device includes a payment device configured to enable the electronic video poker device to be funded via an electronic funds transfer, such as a transfer of funds from a bank account. In another embodiment, the electronic video poker device includes a payment device configured to communicate with a mobile device of a player, such as a cell phone, a radio frequency identification tag, or any other suitable wired or wireless device, to retrieve relevant information associated with that player to fund the electronic video poker device. It should be appreciated that when the electronic video poker device is funded, the at least one processor determines the amount of funds entered and displays the corresponding amount on a credit display or any other suitable display as described below.

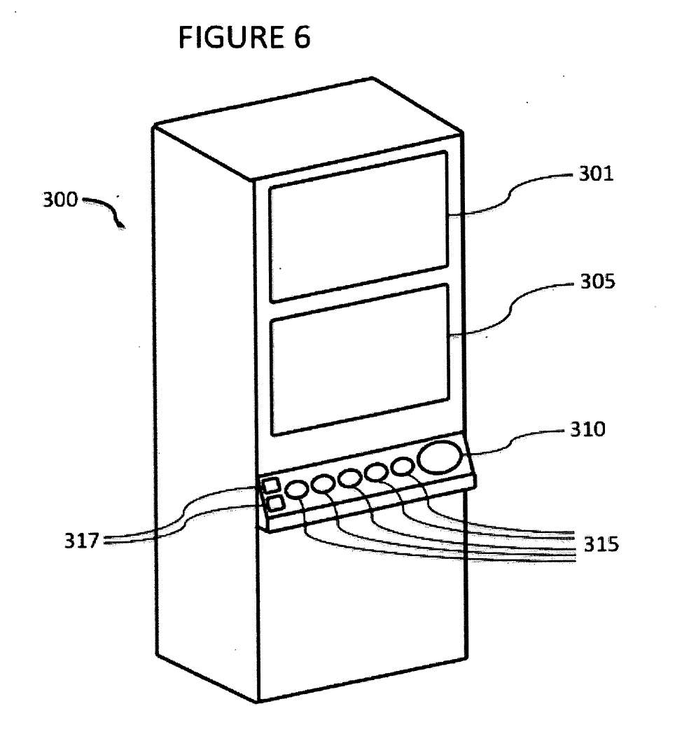

In various embodiments, one or more input devices of the electronic video poker device are one or more game play activation devices that are each used to initiate a play of a game on the electronic video poker device or a sequence of events associated with the electronic video poker device following appropriate funding of the electronic video poker device. The example electronic video poker devices illustrated in FIG. 6. It should be appreciated that, in other embodiments, the electronic video poker device automatically begins game play upon appropriate funding rather than upon utilization of the game play activation device.

In certain embodiments, one or more input devices of the electronic video poker device are one or more wagering or betting devices. One such wagering or betting device is as a maximum wagering or betting device that, when utilized, causes a maximum wager to be placed. Another such wagering or betting device is a repeat the bet device that, when utilized, causes the previously placed wager to be placed. A further such wagering or betting device is a bet one device. A bet is placed upon utilization of the bet one device. The bet is increased by one credit each time the bet one device is utilized. Upon the utilization of the bet one device, a quantity of credits shown in a credit display decreases by one, and a number of credits shown in a bet display increases by one.

In other embodiments, one input device of the electronic video poker device is a cash-out device. The cash out device is utilized to receive a cash payment or any other suitable form of payment corresponding to a quantity of remaining credits of a credit display (as described below). The example electronic video poker devices illustrated in FIG. 6 each include a cash out device in the form of a cash out button.

In certain embodiments, one input device of the electronic video poker device is a touch-screen coupled to a touch-screen controller or other touch-sensitive display overlay to enable interaction with any images displayed on a display device. One such input device is a conventional touch-screen button panel. The touch-screen and the touch-screen controller are connected to a video controller. In these embodiments, signals are input to the electronic video poker device by touching the touch screen at the appropriate locations.

In various embodiments, one input device of the electronic video poker device is a sensor, such as a camera, in communication with the at least one processor of the electronic video poker device (and controlled by the at least one processor of the electronic video poker device in some embodiments) and configured to acquire an image or a video of a player using the electronic video poker device and/or an image or a video of an area surrounding the electronic video poker device.

In embodiments including a player tracking system, as further described below, one input device of the electronic video poker device is a card reader in communication with the at least one processor of the electronic video poker device. The example electronic video poker devices illustrated in FIG. 6 may include a card reader. The card reader is configured to read a player identification card inserted into the card reader.

In various embodiments, the electronic video poker device includes one or more output devices. The example electronic video poker device illustrated in FIG. 5 includes at least one output device 2060. One or more output devices of the electronic video poker device are one or more display devices configured to display any game(s) displayed by the electronic video poker device and any suitable information associated with such game(s). In certain embodiments, the display devices are connected to or mounted on a cabinet of the electronic video poker device (as described below). In various embodiments, the display devices serves as digital glass configured to advertise certain games or other aspects of the gaming establishment in which the electronic video poker device is located. In various embodiments, the electronic video poker device includes one or more of the following display devices: (a) a central display device; (b) a player tracking display configured to display various information regarding a player's player tracking status (as described below); (c) a secondary or upper display device in addition to the central display device and the player tracking display; (d) a credit display configured to display a current quantity of credits, amount of cash, account balance, or the equivalent; and (e) a bet display configured to display an amount wagered for one or more plays of one or more games. One embodiment of the subject electronic video poker device may include a central display device, a player tracking display, a credit display, and a bet display.

In various embodiments, the display devices include, without limitation: a monitor, a television display, a plasma display, a liquid crystal display, a display based on light emitting diodes, a display based on a plurality of organic light-emitting diodes, a display based on polymer light-emitting diodes, a display based on a plurality of surface-conduction electron-emitters, a display including a projected and/or reflected image, or any other suitable electronic device or display mechanism. In certain embodiments, as described above, the display device includes a touch-screen with an associated touch-screen controller. It should be appreciated that the display devices may be of any suitable sizes, shapes, and configurations.

The display devices of the electronic video poker device are configured to display one or more game and/or non-game images, symbols, and indicia. In certain embodiments, the display devices of the electronic video poker device are configured to display any suitable visual representation or exhibition of the movement of objects; dynamic lighting; video images; images of people, characters, places, things, and faces of cards; and the like. In certain embodiments, the display devices of the electronic video poker device are configured to display one or more video reels, one or more video wheels, and/or one or more video dice. In other embodiments, certain of the displayed images, symbols, and indicia are in mechanical form. That is, in these embodiments, the display device includes any electromechanical device, such as one or more rotatable wheels, one or more reels, and/or one or more dice, configured to display at least one or a plurality of game or other suitable images, symbols, or indicia.

In various embodiments, one output device of the electronic video poker device is a payout device. In these embodiments, when the cash out device is utilized as described above, the payout device causes a payout to be provided to the player. In one embodiment, the payout device is one or more of: (a) a ticket generator configured to generate and provide a ticket or credit slip representing a payout, wherein the ticket or credit slip may be redeemed via a cashier, a kiosk, or other suitable redemption system; (b) a note generator configured to provide paper currency; (c) a coin generator configured to provide coins or tokens in a coin payout tray; and (d) any suitable combination thereof. The example electronic video poker devices may include a ticket generator. In one embodiment, the electronic video poker device includes a payout device configured to fund an electronically recordable identification card or smart card or a bank account via an electronic funds transfer.

In certain embodiments, one output device of the electronic video poker device is a sound-generating device controlled by one or more sound cards. In one such embodiment, the sound generating device includes one or more speakers or other sound generating hardware and/or software for generating sounds, such as by playing music for any games or by playing music for other modes of the electronic video poker device, such as an attract mode. In another such embodiment, the electronic video poker device provides dynamic sounds coupled with attractive multimedia images displayed on one or more of the display devices to provide an audio-visual representation or to otherwise display full-motion video with sound to attract players to the electronic video poker device. In certain embodiments, the electronic video poker device displays a sequence of audio and/or visual attraction messages during idle periods to attract potential players to the electronic video poker device. The videos may be customized to provide any appropriate information.

In various embodiments, the electronic video poker device includes a plurality of communication ports configured to enable the at least one processor of the electronic video poker device to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, such as the example electronic video poker devices illustrated in FIG. 6, the electronic video poker device has a support structure, housing, or cabinet that provides support for a plurality of the input device and the output devices of the electronic video poker device. Further, the electronic video poker device is configured such that a player may operate it while standing or sitting. In various embodiments, the electronic video poker device is positioned on a base or stand, or is configured as a pub-style tabletop game (not shown) that a player may operate typically while sitting. As illustrated by the different example electronic video poker devices shown in FIG. 6, electronic video poker devices may have varying cabinet and display configurations.

It should be appreciated that, in certain embodiments, the electronic video poker device is a device that has obtained approval from a regulatory gaming commission, and in other embodiments, the electronic video poker device is a device that has not obtained approval from a regulatory gaming commission.

As explained above, for brevity and clarity, both the electronic video poker devices and the personal gaming devices of the present disclosure are collectively referred to herein as “electronic video poker devices.” Accordingly, it should be appreciated that certain of the example electronic video poker devices described above include certain elements that may not be included in all electronic video poker devices. For example, the payment device of a personal gaming device such as a mobile telephone may not include a coin acceptor, while in certain instances the payment device of an electronic video poker device located in a gaming establishment may include a coin acceptor.

In various embodiments, an electronic video poker device may be implemented in one of a variety of different configurations. In various embodiments, the electronic video poker device may be implemented as one of: (a) a dedicated electronic video poker device wherein computerized game programs executable by the electronic video poker device for controlling any primary or base games (referred to herein as “primary games”) and/or any secondary or bonus games or other functions (referred to herein as “secondary games”) displayed by the electronic video poker device are provided with the electronic video poker device prior to delivery to a gaming establishment or prior to being provided to a player; and (b) a changeable electronic video poker device wherein computerized game programs executable by the electronic video poker device for controlling any primary games and/or secondary games displayed by the electronic video poker device are downloadable to the electronic video poker device through a data network or remote communication link after the electronic video poker device is physically located in a gaming establishment or after the electronic video poker device is provided to a player.

As generally explained above, in various embodiments in which the gaming system includes a central server, central controller, or remote host and a changeable electronic video poker device, the at least one memory device of the central server, central controller, or remote host stores different game programs and instructions executable by the at least one processor of the changeable electronic video poker device to control one or more primary games and/or secondary games displayed by the changeable electronic video poker device. More specifically, each such executable game program represents a different game or a different type of game that the at least one changeable electronic video poker device is configured to operate. In one example, certain of the game programs are executable by the changeable electronic video poker device to operate games having the same or substantially the same game play but different pay-tables. In different embodiments, each executable game program is associated with a primary game, a secondary game, or both. In certain embodiments, an executable game program is executable by the at least one processor of the at least one changeable electronic video poker device as a secondary game to be played simultaneously with a play of a primary game (which may be downloaded to or otherwise stored on the at least one changeable electronic video poker device), or vice versa.

In operation of such embodiments, the central server, central controller, or remote host is configured to communicate one or more of the stored executable game programs to the at least one processor of the changeable electronic video poker device. In different embodiments, a stored executable game program is communicated or delivered to the at least one processor of the changeable electronic video poker device by: (a) embedding the executable game program in a device or a component (such as a microchip to be inserted into the changeable electronic video poker device); (b) writing the executable game program onto a disc or other media; or (c) uploading or streaming the executable game program over a data network (such as a dedicated data network). After the executable game program is communicated from the central server, central controller, or remote host to the changeable electronic video poker device, the at least one processor of the changeable electronic video poker device executes the executable game program to enable the primary game and/or the secondary game associated with that executable game program to be played using the display device(s) and/or the input device(s) of the changeable electronic video poker device. That is, when an executable game program is communicated to the at least one processor of the changeable electronic video poker device, the at least one processor of the changeable electronic video poker device changes the game or the type of game that may be played using the changeable electronic video poker device.

In certain embodiments, the gaming system randomly determines any game outcome(s) (such as a win outcome) and/or award(s) (such as a quantity of credits to award for the win outcome) for a play of a primary game and/or a play of a secondary game based on probability data. In certain such embodiments, this random determination is provided through utilization of an RNG, such as a true RNG or a pseudo RNG, or any other suitable randomization process. In one such embodiment, each game outcome or award is associated with a probability, and the gaming system generates the game outcome(s) and/or the award(s) to be provided based on the associated probabilities. In these embodiments, since the gaming system generates game outcomes and/or awards randomly or based on one or more probability calculations, there is no certainty that the gaming system will ever provide any specific game outcome and/or award.

In certain embodiments, the gaming system maintains one or more predetermined pools or sets of predetermined game outcomes and/or awards. In certain such embodiments, upon generation or receipt of a game outcome and/or award request, the gaming system independently selects one of the predetermined game outcomes and/or awards from the one or more pools or sets. The gaming system flags or marks the selected game outcome and/or award as used. Once a game outcome or an award is flagged as used, it is prevented from further selection from its respective pool or set; that is, the gaming system does not select that game outcome or award upon another game outcome and/or award request. The gaming system provides the selected game outcome and/or award. U.S. Pat. Nos. 7,470,183 and 7,833,092, incorporated herein by reference, describe various examples of this type of award determination.

In certain embodiments in which the gaming system includes a central server, central controller, or remote host and an electronic video poker device, the electronic video poker device is configured to communicate with the central server, central controller, or remote host for monitoring purposes only. In such embodiments, the electronic video poker device determines the game outcome(s) and/or award(s) to be provided in any of the manners described above, and the central server, central controller, or remote host monitors the activities and events occurring on the electronic video poker device. In one such embodiment, the gaming system includes a real-time or online accounting and gaming information system configured to communicate with the central server, central controller, or remote host. In this embodiment, the accounting and gaming information system includes: (a) a player database for storing player profiles, (b) a player tracking module for tracking players (as described below), and (c) a credit system for providing automated transactions. U.S. Pat. No. 6,913,534, incorporated hereby by reference, describes various examples of such accounting systems.

As noted above, in various embodiments, the gaming system includes one or more executable game programs executable by at least one processor of the gaming system to provide one or more primary games and one or more secondary games. The primary game(s) and the secondary game(s) may comprise any suitable games and/or wagering games, such as, but not limited to: electro-mechanical or video slot or spinning reel type games; video card games such as video draw poker, multi-hand video draw poker, other video poker games, video blackjack games, and video baccarat games; video keno games; video bingo games; and video selection games.

In certain embodiments in which the primary game is a slot or spinning reel type game, the gaming system includes one or more reels in either an electromechanical form with mechanical rotating reels or in a video form with simulated reels and movement thereof. Each reel displays a plurality of indicia or symbols, such as bells, hearts, fruits, numbers, letters, bars, or other images that typically correspond to a theme associated with the gaming system. In certain such embodiments, the gaming system includes one or more pay-lines associated with the reels. In certain embodiments, one or more of the reels are independent reels or uni-symbol reels. In such embodiments, each independent reel generates and displays one symbol.

In various embodiments, one or more of the paylines is horizontal, vertical, circular, diagonal, angled, or any suitable combination thereof. In other embodiments, each of one or more of the paylines is associated with a plurality of adjacent symbol display areas on a requisite number of adjacent reels. In one such embodiment, one or more paylines are formed between at least two symbol display areas that are adjacent to each other by either sharing a common side or sharing a common corner (i.e., such paylines are connected paylines). The gaming system enables a wager to be placed on one or more of such paylines to activate such paylines. In other embodiments in which one or more paylines are formed between at least two adjacent symbol display areas, the gaming system enables a wager to be placed on a plurality of symbol display areas, which activates those symbol display areas.

In various embodiments, the gaming system provides one or more awards after a spin of the reels when specified types and/or configurations of the indicia or symbols on the reels occur on an active payline or otherwise occur in a winning pattern, occur on the requisite number of adjacent reels, and/or occur in a scatter pay arrangement.

In certain embodiments, the gaming system employs a ways to win award determination. In these embodiments, any outcome to be provided is determined based on a number of associated symbols that are generated in active symbol display areas on the requisite number of adjacent reels (i.e., not on paylines passing through any displayed winning symbol combinations). If a winning symbol combination is generated on the reels, one award for that occurrence of the generated winning symbol combination is provided. U.S. Pat. No. 8,012,011, incorporated herein by reference, describes various examples of ways to win award determinations.

In various embodiments, the gaming system includes a progressive award. Typically, a progressive award includes an initial amount and an additional amount funded through a portion of each wager placed to initiate a play of a primary game. When one or more triggering events occurs, the gaming system provides at least a portion of the progressive award. After the gaming system provides the progressive award, an amount of the progressive award is reset to the initial amount and a portion of each subsequent wager is allocated to the next progressive award. U.S. Pat. Nos. 5,766,079; 7,780,523; and 7,905,778, describing various examples of different progressive gaming systems, are hereby incorporated by reference.

In addition to providing winning credits or other awards for one or more plays of the primary game(s), in various embodiments the gaming system provides credits or other awards for one or more plays of one or more secondary games. The secondary game typically enables a prize or payout in to be obtained addition to any prize or payout obtained through play of the primary game(s). The secondary game(s) typically produces a higher level of player excitement than the primary game(s) because the secondary game(s) provides a greater expectation of winning than the primary game(s) and is accompanied with more attractive or unusual features than the primary game(s). It should be appreciated that the secondary game(s) may be any type of suitable game, either similar to or completely different from the primary game.

In various embodiments, the gaming system automatically provides or initiates the secondary game upon the occurrence of a triggering event or the satisfaction of a qualifying condition. In other embodiments, the gaming system initiates the secondary game upon the occurrence of the triggering event or the satisfaction of the qualifying condition and upon receipt of an initiation input. In certain embodiments, the triggering event or qualifying condition is a selected outcome in the primary game(s) or a particular arrangement of one or more indicia on a display device for a play of the primary game(s), such as a “bonus” symbol appearing on three adjacent reels along a payline following a spin of the reels for a play of the primary game. In other embodiments, the triggering event or qualifying condition occurs based on a certain amount of game play (such as number of games, number of credits, amount of time) being exceeded, or based on a specified number of points being earned during game play. It should be appreciated that any suitable triggering event or qualifying condition or any suitable combination of a plurality of different triggering events or qualifying conditions may be employed.

In other embodiments, at least one processor of the gaming system randomly determines when to provide one or more plays of one or more secondary games. In one such embodiment, no apparent reason is provided for the providing of the secondary game. In this embodiment, qualifying for a secondary game is not triggered by the occurrence of an event in any primary game or based specifically on any of the plays of any primary game. That is, qualification is provided without any explanation or, alternatively, with a simple explanation. In another such embodiment, the gaming system determines qualification for a secondary game at least partially based on a game triggered or symbol triggered event, such as at least partially based on play of a primary game.

In various embodiments, after qualification for a secondary game has been determined, the secondary game participation may be enhanced through continued play on the primary game. Thus, in certain embodiments, for each secondary game qualifying event, such as a secondary game symbol, that is obtained, a given number of secondary game wagering points or credits is accumulated in a “secondary game meter” configured to accrue the secondary game wagering credits or entries toward eventual participation in the secondary game. In one such embodiment, the occurrence of multiple such secondary game qualifying events in the primary game results in an arithmetic or exponential increase in the number of secondary game wagering credits awarded. In another such embodiment, any extra secondary game wagering credits may be redeemed during the secondary game to extend play of the secondary game.

In certain embodiments, no separate entry fee or buy-in for the secondary game is required. That is, entry into the secondary game cannot be purchased; rather, in these embodiments entry must be won or earned through play of the primary game, thereby encouraging play of the primary game. In other embodiments, qualification for the secondary game is accomplished through a simple “buy-in.” For example, if qualification through other specified activities fails, payment of a fee or placement of an additional wager “buys-in” to the secondary game. In certain embodiments, a separate side wager must be placed on the secondary game or a wager of a designated amount must be placed on the primary game to enable qualification for the secondary game. In these embodiments, the secondary triggering event must occur and the side wager (or designated primary game wager amount) must have been placed for the secondary game to trigger.

In various embodiments in which the gaming system includes a plurality of electronic video poker devices, the electronic video poker devices are configured to communicate with one another to provide a group gaming environment. In certain such embodiments, the electronic video poker devices enable players of those electronic video poker devices to work in conjunction with one another, such as by enabling the players to play together as a team or group, to win one or more awards. In other such embodiments, the electronic video poker devices enable players of those electronic video poker devices to compete against one another for one or more awards. In one such embodiment, the electronic video poker devices enable the players of those electronic video poker devices to participate in one or more gaming tournaments for one or more awards.

In various embodiments, the gaming system includes one or more player tracking systems. Such player tracking systems enable operators of the gaming system (such as casinos or other gaming establishments) to recognize the value of customer loyalty by identifying frequent customers and rewarding them for their patronage. Such a player tracking system is configured to track a player's gaming activity. In one such embodiment, the player tracking system does so through the use of player tracking cards. In this embodiment, a player is issued a player identification card that has an encoded player identification number that uniquely identifies the player. When the player's playing tracking card is inserted into a card reader of the gaming system to begin a gaming session, the card reader reads the player identification number off the player tracking card to identify the player. The gaming system timely tracks any suitable information or data relating to the identified player's gaming session. The gaming system also timely tracks when the player tracking card is removed to conclude play for that gaming session. In another embodiment, rather than requiring insertion of a player tracking card into the card reader, the gaming system utilizes one or more portable devices, such as a cell phone, a radio frequency identification tag, or any other suitable wireless device, to track when a gaming session begins and ends. In another embodiment, the gaming system utilizes any suitable biometric technology or ticket technology to track when a gaming session begins and ends.

In such embodiments, during one or more gaming sessions, the gaming system tracks any suitable information or data, such as any amounts wagered, average wager amounts, and/or the time at which these wagers are placed. In different embodiments, for one or more players, the player tracking system includes the player's account number, the player's card number, the player's first name, the player's surname, the player's preferred name, the player's player tracking ranking, any promotion status associated with the player's player tracking card, the player's address, the player's birthday, the player's anniversary, the player's recent gaming sessions, or any other suitable data. In various embodiments, such tracked information and/or any suitable feature associated with the player tracking system is displayed on a player tracking display. In various embodiments, such tracked information and/or any suitable feature associated with the player tracking system is displayed via one or more service windows that are displayed on the central display device and/or the upper display device. U.S. Pat. Nos. 6,722,985; 7,611,411; 7,617,151; and 8,057,298, incorporated herein by reference, describe various examples of player tracking systems.

It should be understood that various changes and modifications to the present embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A gaming system comprising:
at least one processor;
at least one display device;
at least one input device; and
at least one memory device storing a plurality of instructions which, when executed by the at least one processor, cause the at least one processor to operate with the at least one display device and the at least one input device, for a play of a card game, to:
(a) determine a player set of at least five cards from a plurality of cards;
(b) display face-up the cards of the player set;
(c) receive, from the player, first hand formation inputs associated with the cards of the player set placed into one of the thirteen positions forming a top hand, a middle hand, and a bottom hand;
(d) receive, from the player, a draw input;
(e) determine an automatic system set of at least eight cards from the remaining plurality of cards;
(f) determine position placement for each of the cards in the automatic system set based on a pre-defined pay-table; and the bottom hand beating the middle hand and the middle hand beating the top hand;
(g) display face-up the cards of the automatic system set;
(h) determine any awards based on the a pre-defined pay-table and the bottom hand beating the middle hand and the middle hand beating the top hand; and
(l) display and provide any determined awards.

2. The gaming system of claim 1 wherein the player set comprises thirteen cards and either the gaming system or the player sets position of each card one at a time.

3. The gaming system of claim 1 wherein the player set comprises thirteen cards and the player sets cards 6-13 dealt one card at a time to be placed one at a time until all thirteen cards are placed, whereby once a card is placed it cannot be moved after the next card is dealt.

4. The gaming system of claim 1 wherein the player set comprises thirteen cards and the player sets cards 6-13 being dealt three cards at a time to be placed two cards at a time until all thirteen cards are placed, whereby once the two cards are placed, they cannot be moved after the next three cards are dealt.

5. The gaming system of claim 1 wherein the card game comprises internet gambling and social gaming.
